(19) United States
(12) Patent Application Publication
(10) Pub. No.: US 2013/0247100 A1
(43) Pub. Date: Sep. 19, 2013

(54) METHOD AND APPARATUS FOR PROVIDING A PROGRAMMING GUIDE VIA MULTIPLE RECEIVING DEVICES

(71) Applicant: ROVI TECHNOLOGIES CORPORATION, Santa Clara, CA (US)

(72) Inventor: Ronald Quan, Cupertino, CA (US)

(73) Assignee: Rovi Technologies Corporation, Santa Clara, CA (US)

(21) Appl. No.: 13/890,872

(22) Filed: May 9, 2013

Related U.S. Application Data
(62) Division of application No. 12/908,808, filed on Oct. 20, 2010, now abandoned.

(51) Int. Cl. H04N 21/482

(52) U.S. Cl. CPC H04N 21/4821
USPC 725/39

(57) ABSTRACT

A system utilizing one or more auxiliary or scanning tuners provides real time information for providing programming guides. The one or more auxiliary tuner scans or tunes across the band of television signals to gather information relevant to metadata, programming guides, and or message alerts. For example, this information is converted to text, graphic, and or audio form for displaying or listening.

### BACKGROUND

The present invention pertains to programming guides in television (TV) sets, personal video recorders (PVR), and or other media devices.

Prior configurations for displays or media devices have utilized multiple tuners for main channel viewing and or picture in picture (PIP) viewing.

For example, a conventional system is illustrated in FIG. 1A, which shows an antenna or RF source coupled to an input of a main tuner 101. An output of main tuner 101 provides a digital or analog video signal of a first selected television channel, to an input of a recorder and or display 103. A second tuner 102, provides a digital or analog video signal, which is then displayed via the recorder and or display 103, as a smaller picture within a main picture.

Currently in some digital television (DTV) tuners, basic program information is sent as part of the main digital signal transmission, or as a secondary channel of a particular channel. In order to retrieve or display the basic program information, the tuner must be scanned or selected one channel at a time to capture the basic program information. While the tuner is scanned or selected one channel at a time, the user has no access to viewing program information on a main channel.

### SUMMARY

It is an object and advantage of the invention to allow normal viewing of main video programs on a main channel while allowing the gathering or retrieval of programming information. Such retrieved programming information then may be displayed, for example, in a portion of the video field such as a top, bottom, or side panel, or a letterboxed panel, while allowing viewing of the main program. Alternatively, the retrieved programming information, or additional information, may be inserted, mixed, or dissolved into an area of the active video field. An example of such an area of the active video field may include a viewable picture area in one or more corner of the active video field.

Another example of an area of the active video field for displaying added information includes at least a portion of the area where a station logo resides. Since a station logo already takes up a portion of the viewing area with the same message throughout one or more programs, the space occupied by the logo may serve to include other information such as the retrieved programming information, or additional information, which may change with time. Alternatively, the retrieved programming information or additional information which is displayed may be multiplexed in time with the logo: for example, displaying 3 seconds of logo followed by one to 10 seconds of the additional information (e.g., programming information for any channel, weather, etc.). Control is provided for a user to activate enabling or disabling the display of the programming or additional information.

It should be noted that future displays in an embodiment may not necessarily comply with a standard 4:3 or 16:9 aspect ratio of a conventional television picture. For example, displays may allow some extra space on the side or corner thereof to display additional information, while substantially not interfering with the area of view for the main channel.

Alternatively, in another embodiment, if additional information of any kind is to be displayed, the main channel is provided with a dissolve or a mix of text over the main program channel. Further, providing a reduction in one or more sides or portions of the main program allows displaying additional information of any kind.

In yet another embodiment, additional information of any kind is displayed on an auxiliary device associated with a media display or device. An example of an auxiliary device may include a remote control and or a phone, or second media device.

In another embodiment, the additional information is converted to an audio signal and is provided to the user for retrieval. For example, an unused audio channel, an unused channel space, or a dedicated channel may provide an audio version of the additional information.

In yet another embodiment, the additional information is encoded in a portion of the video signal, such as in a portion of one or more vertical blanking interval(s) and or one or more horizontal blanking interval(s). Encoding the additional information in a portion of a video signal allows distribution or transmission of the information into another media device that can retrieve the additional information (e.g., without an extra tuner).

A programming guide utilizing multiple receiving devices allows the searching or scanning of video/audio channels from an RF signal or band of RF signals to provide uninterrupted viewing while updating a programming guide for a set top box, display, receiver, and or recorder/playback device. Alternatively, the programming guide may assemble data from a digital delivery network for one or more video/audio programs. Thus, the programming guide allows the gathering of related data without interruption of viewing by the user from one channel to another channel.

A system comprising multiple tuners or receivers for recovering RF and or Web based information is used to update or to provide a programming guide for a media device. The media device may include a set top box, display, receiver, cell phone, and or the like.

For example, having a dedicated tuner and or Web base receiver allows information to be provided and or updated for a programming guide. The provided or updated information may include emergency alerts, news, weather, etc., which can be integrated into a section of the programming guide. The provided or updated information may include information for any or each channel scanned by the tuner or the Web.

In another embodiment multiple tuners gather information more efficiently than a single tuner, which allows for faster accumulation of additional or “extra” information that is stored and or displayed.

### BRIEF SUMMARY OF THE DRAWINGS

FIG. 1A is a block diagram illustrating a conventional receiver, display, or recording device.

FIG. 1B is a block diagram illustrating an embodiment of the invention.

FIG. 2 is a block diagram illustrating another embodiment.

FIG. 3 is a block diagram illustrating an embodiment including multiple tuners.

FIG. 4 is a block diagram illustrating an embodiment including one or more tuners.

FIG. 5 is a block diagram illustrating an embodiment for displaying information.

FIG. 6A is a block diagram illustrating another embodiment for displaying information.

FIG. 6B is a block diagram illustrating yet another embodiment for displaying information.

### DETAILED DESCRIPTION

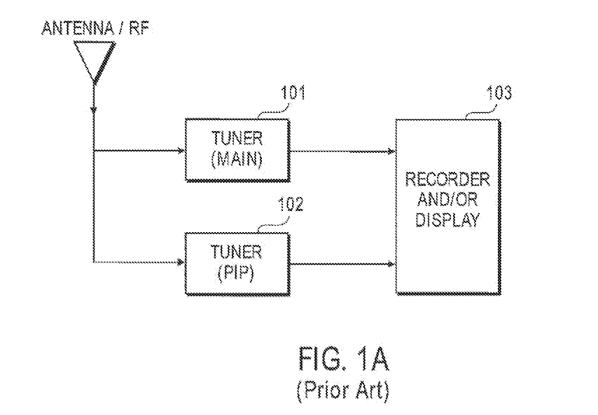

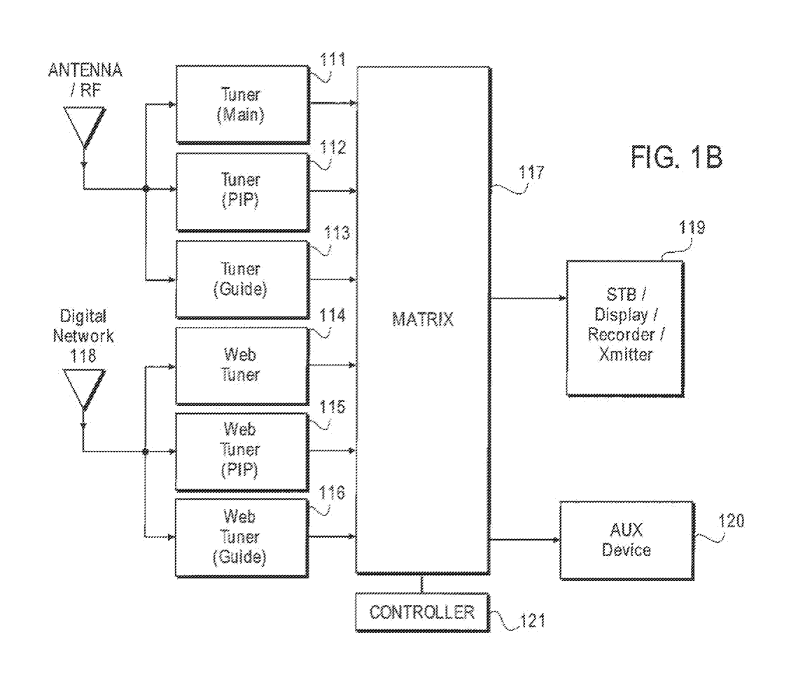

An example of an embodiment is illustrated in, but not limited to, the embodiment of FIG. 1B. In this embodiment, a main tuner 111 is used primarily for main channel viewing of video programs. A separate picture in picture (PIP) tuner 112 may display other channels. A “searching” or “scanning” tuner 113 may search or scan in the background to gather information or signals relevant to updating a programming guide. Any combination of the tuners 111, 112, and or 113 are employed independently or dependently.

Similarly, video signals from a digital delivery network 118 may include a main viewing tuner 114 from the Internet or equivalent source, a PIP tuner 115 for a secondary Internet channel, and a guide tuner 116 dedicated to searching for information for various programming on the Web.

The output(s) of one or more of the tuner(s) 111 through 116 are coupled to a matrix function or circuit 117, which then provides a processed signal to a set top box (STB), display, recorder, and or transmitter device 119. The matrix function steers video signals and data signals to allow for viewing, recording, and or transmitting a video signal (with an updated programming guide).

An auxiliary device 120 is shown coupled to the matrix function 117 and may include a cell phone, computer or controlling circuit to input requests or to search the web. The auxiliary device 120 may include monitoring the programming guide separate from a main display.

A controller 121 is coupled to the matrix function 117 to enable selecting channels from any of the tuners (e.g., 111-116) for display, for storage/recording, and or retrieving programming data via any of the guide receiving devices such as tuner 113 and or 116.

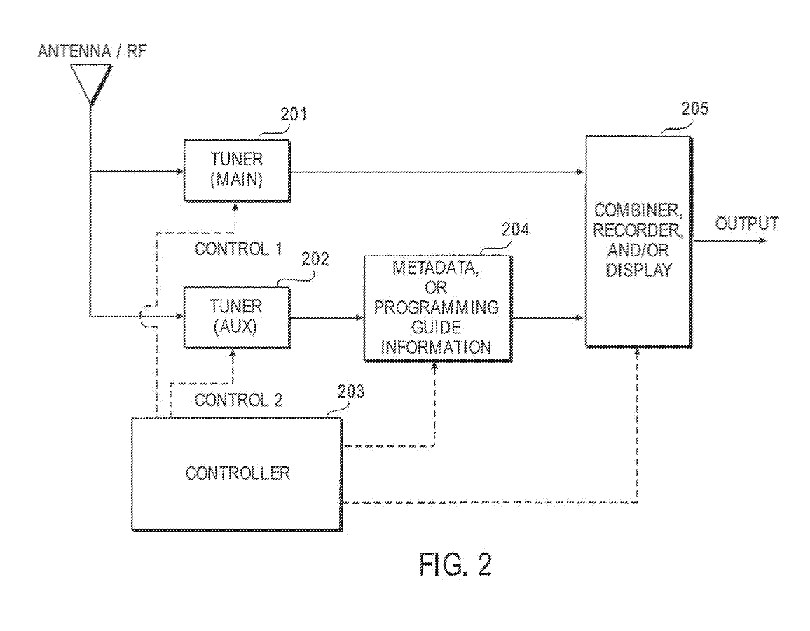

FIG. 2 illustrates another embodiment, wherein an RF source or antenna is coupled to an input of a first tuner 201, and wherein an output of the first tuner is coupled to a combiner, recorder, and or display 205. The first tuner 201 may be used as a “main” tuner for displaying or providing a video signal to the combiner, recorder, and or display 205. Selection of a particular channel from the tuner 201 for viewing is provided via a controller circuit 203, which may be implemented as a function or module. The controller 203 may step through one channel at a time to scan channels which have sufficient signal strength into an auxiliary tuner 202, and to store those channels to be rescanned again for collection of the additional or extra information.

Alternatively, the user may input one or more channel numbers (via the controller 203) for collection of the additional or extra information.

Yet another embodiment may include the user entering the name of a country and or a zip code, wherein a lookup table assigns channels to be scanned to provide the additional or extra information. For example, in the San Francisco Bay Area, a user may enter the zip code 94109, and the controller will direct the auxiliary tuner 202 to scan for channels 2, 4, 5, 7, 9, 20, 44, etc.

As tuner 202 is scanned or stepped, for example via the controller 203, metadata, programming guide information, weather reports, and or alerts for each channel that is tuned in, is stored via a metadata or data reader 204. Accordingly, one or more channels are scanned or stepped through for a duration of time to extract additional or extra information to be read and or stored via an input to the metadata or data reader 204. An output of the reader 204 is coupled to the combiner, recorder, and or display 205.

It should be noted that the additional or extra information collected may be associated with a time-stamp, such as time and or date information received from any of the channels via the antenna or RF source, or as time and or date entered by a user.

The combiner, recorder and or display 205 may record a log of the updates or the additional or extra information collected in a periodic or aperiodic manner. The extra information may be displayed as an overlay over a portion of the main viewing channel, or in some location of the display near the corner and or side thereof For example, a main channel maybe displayed, with a letterbox area at the top and or bottom that is normally gray or black. A portion of the gray or black area of the display may include the information collected via tuner 202; that is, an area for displaying program information of selected or scanned channels.

The output terminal of the combiner, recorder and or display 205 may include a video signal, with extra data inserted in a portion of the viewable television field to enable viewing the extra data. Alternatively, the extra data may be encoded in an overscan region of a video signal such as by adding or inserting a signal in a portion of one or more horizontal and or vertical blanking intervals.

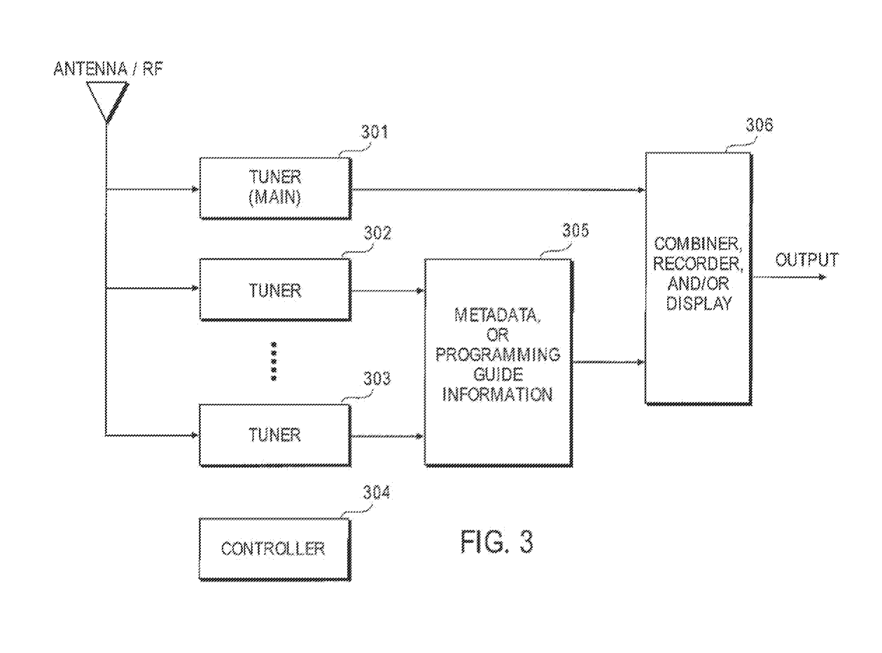

FIG. 3 illustrates another embodiment wherein a video program main tuner 301 receives an RF signal from an RF source or antenna at its input. An output of main tuner 301 is coupled to an input of a combiner, recorder and or display 306 for recording and or displaying program video. Additional multiple tuners 302 and 303 are coupled to the combiner/recorder/display 306 to gather data, programming information, metadata, or the like, from the RF source or antenna, under control of a controller 304. By using multiple tuners, the duration for information gathering is reduced. For example, tuner 302 may gather information from a first set of channels, and tuner 303 may gather information from a second set of channels. The sets of channels may be substantially mutually exclusive, such as having few or no channels in common. For example, in terms of sets, the intersection of the first and second sets of channels equals the null set. A data reader 305, which receives or extracts information (e.g., programming guide, message alert(s), metadata) from tuner 302 and or 303 provides a signal to combiner/recorder/display 306, which allows recording or storing or displaying the information from the data reader 305.

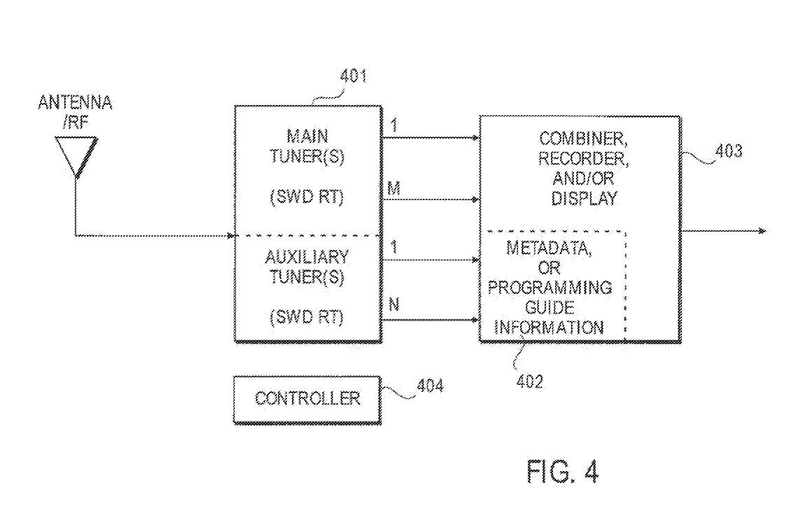

FIG. 4 illustrates an embodiment utilizing a software defined radio or tuner approach/method/system. An antenna or RF source is coupled to an input of one or more software defined radio tuner(s) (SWDRT), depicted as block 401. A SWDRT is a system wherein a radio or television tuner can be configured via programming bits or codes to synthesize one or more building block of a tuner: such building blocks as frequency synthesizers, oscillators, mixers, intermediate frequency systems/amplifiers or filters, or demodulators (e.g., amplitude, phase, frequency, pulse code, MPEG, Wavelet, etc.). One set of SWDRTs may be programmed or configured to include providing one or more main television channels via for example, 1 to M main channel tuners, and or providing one or more auxiliary television channels via for example, 1 to N auxiliary channel tuners.

As depicted in FIG. 4, the outputs of the 1 through N auxiliary tuners are coupled to a reader 402 for metadata, messages, and or programming guide information. The reader 402 transforms or converts the information, messages, and or data to a signal suitable for recording and or displaying via a combiner, recorder and or display 403.

Depending on the programming of the SWDRTs, the (M+N) tuners available in block 401 allows devoting any number of tuner or tuners for a main tuner and or an auxiliary tuner, For example, if one main tuner is selected, then [(M+N)−1] tuners are available for auxiliary functions such as gathering data or for providing PIP (picture in picture) signals. In another example, if multiple main programs are selected for [(M+N)−1] main channel tuners to provide [(M+N)−1] video signals for displaying or recording, then that would leave one auxiliary tuner available for gathering data.

A controller 404 is coupled to the blocks 401, 402 and 403 to configure SWDRTs of block 401, and or to provide one or more commands to record video or data, and or to display video or data (e.g., data converted to text and or graphics, and or data converted to an audio signal).

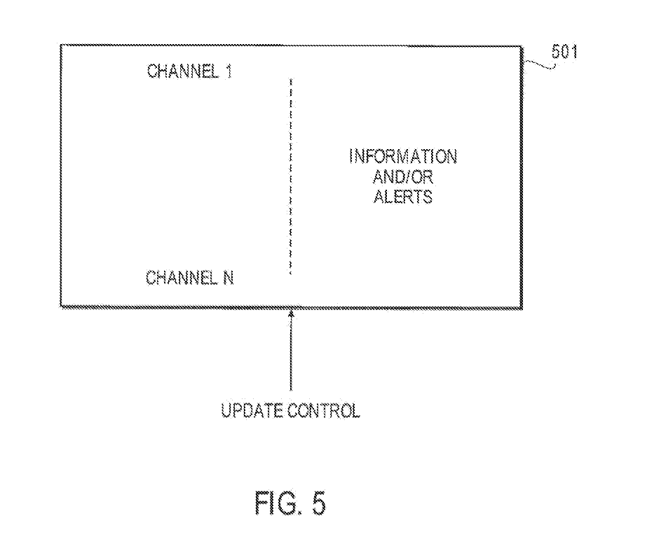

FIG. 5 illustrates an example display of the information associated with one or more channels scanned or received via one or more auxiliary tuners. In this example a list or chart of one or more channels includes information such as title of past, current, and or future programs, messages or alerts (news and or emergency alerts). Alternatively, from the information gathered via one or more auxiliary tuners, an electronic and or interactive programming guide may be synthesized for viewing, displaying or recording.

For example, a displayed information guide 501, may include periodic or non periodic, or emergency over-ride type of update information via an update control signal.

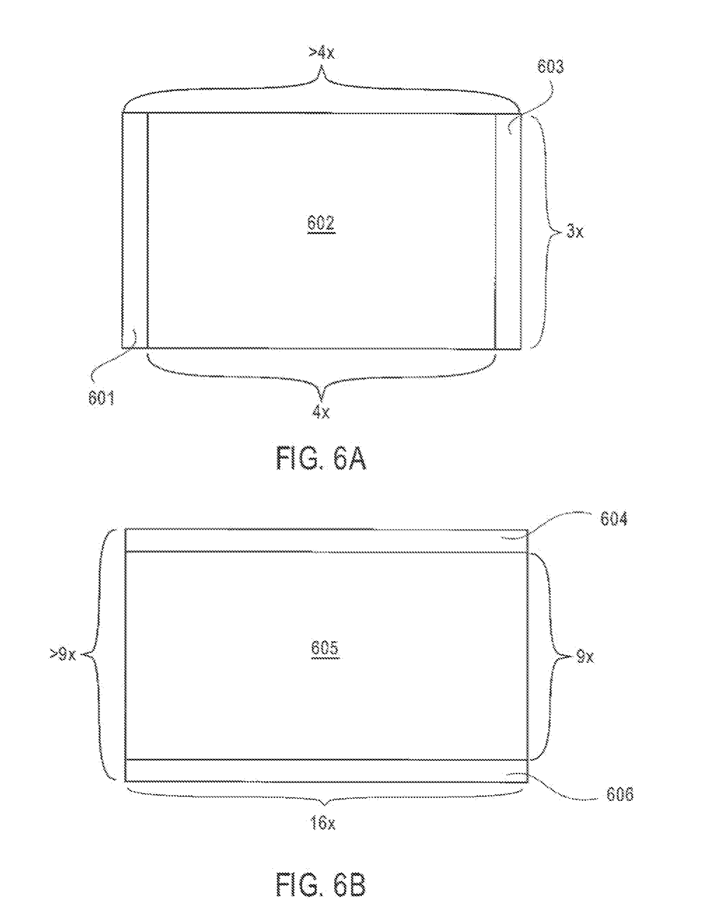

FIGS. 6A and or 6B illustrate embodiments wherein information via one or more auxiliary tuner(s) are displayed in a portion of a letterbox region such as in regions 601, 603, 604, and or 606. FIGS. 6A and or 6B may provide a display whose aspect ratio is not exactly 4:3 or 16:9. For example, the aspect ratio may be 4x:3 or 16x:9x, where x>1.

Alternatively, to display information via the one or more auxiliary tuners, a display of any aspect ratio may be set to an oversean mode in one or more dimensions to allow viewing of the extra information. For example, a display may be set to have a border or perimeter of space around one or more sides (e.g., 1 to 4 sides), which results in shrinkage, geometric compression, or truncation of the main channel's display.

It should be noted that an embodiment may include (e.g., on its own or in combination with any other embodiments) a programming guide, such as an electronic programming guide (EPG) and or interactive programming guide (IPG). Programming guides may be included in a receiver, tuner, media player, and or display device.

U.S. Pat. No. 5,479,268 (the '268 patent) and US Patent Publication No. 2003/0149980 (the '980 publication) both are incorporated by reference, pertain to programming guides such as EPG and IPG, and are both incorporated by reference herein in their entireties. An exemplary programming guide, which may be provided or derived via an IPG or EPG signal, is for example a method or apparatus allowing a user to select one or more (favorite) video channel(s). The guide includes providing to a display, for example, via a screen, a number of cells representing a corresponding number of video channels available for viewing by a user, where each cell includes a channel number and/or a program service name for a particular channel. The user uses the display to select a channel among the number of channels; for example, in response to the user selection, changing a status of the selected channel to that of a favorite channel, or displaying in cells corresponding to the favorite channels a visual indication that the selected channels are favorite channels, and providing program guide information for the subset of channels having said favorite status in response to the user's indication to view the program guide information.

Another example of a programming guide includes a method or apparatus for navigating about a television or video listing including one or more steps of storing in electronic or computer readable memory a number of television or video program listings, each listing including title, telecast time, and/or channel; displaying on a monitor screen some of the titles of the program listings in a grid format of time and channel; moving a cursor on the screen to mark one or more of the displayed titles in the grid guide format; selecting the marked title in a single or multiple format, which may instead be of the (original) grid guide format, where the single channel format includes rows (or columns) of sequential television or video program listings for the channel corresponding to the marked title; additionally including moving the cursor on the screen to mark a different displayed title in the single channel format; where the storing step stores programming listings and/or the displaying step displays the program notes corresponding to the marked title simultaneously with the program listings.

Such a grid pattern or cell may include straight or curved segments. Alternatively, a two dimensional grid pattern may be transformed to a three dimensional grid pattern or vice versa. Such a grid pattern may include three and/or two dimensional properties. For example, one cell to another cell in the programming guide may be represented in a curved surface and/or in a solid object's sides. Cells may be of regular and/or irregular shape(s).

Guide cells currently include a short description of programs such as titles, but not much more. Accordingly, an embodiment of the invention for a programming guide includes real time or near real time updates in the cell. For example, if BBC news is displayed in the guide, a short headline or crawling words may be inserted within the cell with, for example, the latest news or weather.

The cell may be clicked upon for photos, small sized video, and or audio tracks, which may provide a teaser or sample of the program associated with the one or more cells in the guide.

Also, one or more cells may be enlarged in an opaque or transparent manner to show more information such as a short video clip, text information, and or another menu or link for other related information.

Additionally, in case of local or national emergencies, text information or other types of warnings (e.g., announcements, areas affected, etc) may be inserted in any of the cells of the programming guide or any sufficient number of cells to catch the attention of the viewer.

Presently, guide cursors move the whole family of TV channels forward or backward in time. Advantageously, an embodiment of the invention includes a programming guide or programming guide feature wherein the cursor slips or slides only one, or less than all, of the television channels forward or backward in time. This is particularly useful when a viewer is interested in looking ahead of the usual (present) time of a particular channel. A command may be enabled to resynchronize the one or more slipped channel(s) back to the “present” time.

Another embodiment includes a programming guide that allows slipping, offsetting, and or sliding one or more cells, but less than all cells, up or down (e.g., cells offset in one or more directions in one or more columns, or along a first axis of the programming guide), and or sideways (e.g., cells offset in one or more rows, or along a second axis of the programming guide). Alternatively in a programming guide, the cells may move, slide, and or slip at an angle (e.g., in a range 0 to 360 degrees inclusive).

An embodiment may include a log or a recording of the navigation of the programming guide. Occasionally, a user selects/navigates a guide or flips through a cell or channel to select a particular video program, but cannot recall where it was seen. Thus, by playing back the sequence of guide navigation or flips through the cells, the user can locate that particular program. Ergo, an embodiment includes the capability of recording or storing one or more sequences or steps of navigating around a programming guide. The capability of recording or storing one or more sequence of events concerning navigation of a programming guide or channel selection provides a database for analyzing a particular user's viewing habits or for analyzing a user's method of selecting a program. For example, the Nielsen television ratings company would use such data pertaining to how, and or what, a user selects for a television program. It follows that the stored data or real time data as described above may be transmitted to the Nielsen television company for analysis.

Another embodiment may include a programming guide or programming guide feature wherein one or more cells of the programming guide has its background modulated in a manner to provide auxiliary information, such as snippets of audio and or video information, or to include text information. To the untrained viewer, the background color of the one or more cells may look like random or periodic noise.

For an electronic programming guide, extra information is encoded in one or more cells via a spread spectrum, VSB (vestigial side band), AM, FM, PM, PSK, FSK, PCM, delta modulation, and or the like. The extra information may include a low resolution version of audio and or video information for the one or more cells, text information, and or alert messages. Luminance Y, Pb, and or Pr (or R, G, and or B) channels may be encoded with one or more of the various signals as described above.

For, HDTV or even higher HDTV systems or signals, the encoding of auxiliary information may be increased to a rate that allows showing at least high quality standard definition videos by encoding signals in the one or more cells. For example, various super or ultra definition standards are in the works presently, which will increase the pixel information of the 1K×2K current HDTV standard to 2K×4K or 4K×8K. With such much higher density of pixel rates, a dedicated programming guide channel is capable of displaying/providing much more extra information or signals.

Another embodiment includes a programming guide or programming guide feature that includes various cells for a set top box and or television system, wherein memory is set aside to provide links for each channel displayed. For example, one or more television shows include a link to enable the viewer to see a web version of the “broadcast” version. Thus for example, if an episode of a news show is missed, the programming guide provides a link to the web or to a digital delivery network whereby the viewer has an alternative for catching up on the missed program. Accordingly, if a viewer misses a show or program, there is an alternative for going back to view a sample or some version of the missed show or program, without having to log onto a computer and do a search. In essence, the invention allows a viewer to go back to listen to and or view past programs.

Hyperlinks are included in one or more cells for past, present, and or future programs in the EP G to allow viewers to obtain an alternative viewing of the programs listed on the guide.

Yet another embodiment includes a programming guide or programming guide feature that includes various cells for a set top box and or television system, wherein memory is set aside to record at least snippets of audio and or video material for each channel displayed. For example, one or more television shows in one time zone, such as the Pacific time zone, may include snippets of programs from the Eastern Time Zone which were already broadcast. It follows that a look ahead on a news show thus is viewable via the programming guide. Accordingly, a viewer can preview a show or program and can decide if the future program is worth recording.

Multiple tuners (audio and or video) allow previewing information provided by the rights owners whereby a viewer with a programming guide can decide whether to view and or to record programs listed in the future.

Alternatively, hyperlinks may be included in one or more cells to link the past, present, and or future cells to audio and or video snippets or substantially whole episodes of the selected programs.

Yet another embodiment may include a programming guide, a remote control, and or remote control feature to allow viewing a program via a set top box, television set or display, wherein the remote control comprises a separate tuner and or link to a digital delivery network. The remote control may include a display for viewing programming guides linked to, or synchronized with, the set top box, television set and or display device.

The remote control can search/scan for a set of channels or programs via an RF link, and or search/scan for a set of programs via a digital delivery network. After one or more search or scan, a programming guide or summary is provided at the remote control. The programming guide or summary may be sent to the set top box and or display.

Alternatively, the remote control may “import” the existing programming guide from the set top box and or display device and provide additions and or deletions to manage the programming guide. The resulting managed programming guide from the remote control may be uploaded to the set top box and or display device.

Yet another example of the remote control is a remote control that monitors and updates the one or more parameters set by the set top box or display device. For example, the remote control may display to the user what channel or video program is being displayed on the main portion of the screen and or on the picture in picture (PIP). Further, the remote control may display which programs are being recorded or set to be recorded, and or may allow editing of record times or channels or videos to be recorded.

Generally, the remote control may be a software application that generally is installed in a remote control device, but may be applied to a computer, a cell phone, or other (wireless) device.

With memory or storage in the remote control device, a recording or log of the programming guide and or a recording of messages or video/audio programs, may be provided. The remote control may move/transmit the one or more recordings to another location via a link or port.

Another embodiment may include a remote control linked to a device (A) such as a set top box, receiver, display, media player, recorder, and or transmitter, and includes a receiving circuit to independently search or scan television channels for information relevant to programming guides. Alternatively the remote control may receive the video signals on its own via a link to RF or digital signals, and may implement the channel scanning or searching for the programming guide information. Yet another embodiment includes the remote control having the capability to upload or send information to the set top box, receiver, display, recorder, and or transmitter, for providing information on programming guides and or for providing other video/audio signals or messages.

An embodiment of the invention includes a remote control with a receiver or tuner that is able to tune television channels. Data is extracted from one or more channels, which may be stored in the remote control. The extracted data may then provide information to synthesize an electronic programming guide that can be viewed within the remote control. Alternatively, the information pertaining to the electronic programming guide may be sent, transmitted or coupled to a set top box, receiver, display, media player, recorder, and or transmitter.

In another embodiment, an RF signal is coupled to a device (of previous mention) and to a frequency translation or frequency processing device. The output of the frequency translation or frequency processing device is then able to send, or couple a signal to, the remote control. For example, the frequency processing device may receive one or more RF signals from an antenna, television dish, or cable system/device, and up convert the signal to a 60 GHz signal. The 60 GHz signal is sent out or transmitted to the remote control device, which has a 60 GHz receiver/demodulator and or a frequency down converter. The down converted output is coupled to a receiving or decoding/demodulator circuit so that the remote control may scan the one or more channels. The remote control may include a display device to display videos, text, and or programming guides, which may include audio information from the one or more channels.

Yet another embodiment may include a remote control linked to a device such as a television set. The embodiment includes a display screen and or transducer for monitoring the channel status, and or other settings of the television set such as contrast, brightness, color saturation, color hue, sharpness, resolution setting, aspect ratio setting, teletext, closed caption, audio configuration (e.g., stereo, mono, L, R, surround sound, tone control settings, SAP (Secondary Audio Program), DVS (Descriptive Video Service)). In this example embodiment, the remote control provides the information on its own display and or transducer to allow unhampered/uninterrupted viewing/listening of a main channel on the television set. Usually when a viewer looks for information such as audio levels, contrast, etc, the main screen's video program is switched over to a menu, which interrupts viewing and or listening.

In addition, a remote control which includes a “preview” mode, such as for displaying the present aspect ratio and or a different aspect ratio for picture display, the viewer can select the correct aspect ratio on a first attempt (via the remote control's display) instead of having to scroll through various aspect ratios on the main screen until an optimal aspect ratio is available for selection.

Such a preview mode in the remote control may include selection of languages, for example, in the secondary audio program/descriptive video service (SAP/DVS) channels on the remote control without overlaying/inserting that information onto the main screen.

Accordingly, it is an embodiment of the invention to provide a preview mode for a remote control of various control settings related to audio and or video, that allows a more uninterrupted viewing/listening on a main screen/speaker, while allowing settings to be tried out first in a secondary screen or transducer in the remote control.

A further embodiment allows monitoring a channel, audio level, and or other setting on the remote control without having the channel number or other information on the screen. This feature is useful when a recording of a video source is made via a set top box and a recorder. Conventionally, if a viewer is not sure what is being recorded, the typical remote control displays the channel from the set top box, and thus the channel number displayed on the main screen would end up being recorded. As an example, the new remote control is able to display the channel from the set top box or other device via a bidirectional link. The remote control may be communicated via an optical, RF, wireless, and or wired link.

One or more applets or programs may be written to enable an aspect of the invention for application to cell phones, wireless devices, receivers, tuners, routers, cameras, memory devices, and or the like. For example, a cell phone such as an iPhone or other device like iTouch, iPad, or iPod (that includes a receiver and or transceiver) may be used to implement one or more aspects or embodiments of the invention.

Still another embodiment may comprise a remote control including a receiver for application to the Internet and or RF (Broadcast), and or a link to a set top box, television set, recorder, or the like. An example of such remote control includes a display (and or transducer) for programming guides, which includes widgets, and or advertisements in video and or audio. A widget for example may include an executable program, a short cut, or alias that enables a program. An example of an executable program includes one or more combination of displaying/providing the weather, Amber Alerts, emergency alerts, news alerts, etc.

A remote control that can adjust settings and change channels for a set top box, display, or other device, includes a link to the Internet or a digital delivery network such that widgets and or advertisements may be coupled to the remote control. During selection of programs in the remote control, widgets can complement the user experience for viewing weather reports, emergency alerts, video clips, etc.

It should be noted that in one embodiment a remote control may include advertisement that is displayed and or audible within the remote control. Updates on the advertisement may be done via a receiver or tuner or communications link in the remote control. Alternatively the remote control may include a storage device (e.g., memory, hard drive, etc.) wherein the storage device may store commercials or advertisement information or signals that can be later shown to or heard by the user of the remote control. The storage device may store other information, e.g., history of use of the remote control, or sequences of selections done on the remote control.

Still further, an embodiment may include a programming guide including a grid pattern of cells in a two or more dimensional plane, surface, or solid. The grid pattern (array) may include an alpha-numeric sequence along one or more axis. A user can select a particular row or column of cells, and or the user can select a cell associated with a program within a selected row or column of cells. Alternatively, the cells can be identified/located much like a map of a city by a sequence of numbers and or letter in the “X”, “Y”, and or “Z” axis, wherein two or more successive letters and or numbers are indicative of a particular cell. The user may enter the successive letter and or numbers (e.g., in a keypad) to have direct access to a channel and or program, rather than, for example, having to scroll through the cells in the grid pattern array. For example, one axis may be labeled A-Z (or 1-100 or 200-300), and another axis labeled A-Z (or 1-100 or 200-300), wherein the user locates the cells by the two or more axes and enters a coordinate such as A4,AK, or 15J, etc. for selection of the cells. The cells themselves may have letters and or numbers of identification and or entry on a keypad for access.

A keypad may include a comma or “,” in one of the keys. For example, if there are numerical entries, the comma (between number entries) allows certainty or lack of confusion as to what is being entered. For instance a cell located in the “X” axis as 23 and “Y” axis as 35, the user enters 23, 35 instead of an ambiguous entry of 2335. However, the cells may be encoded in a manner such that entries without a comma can lead to the correct selection of the cell. In the example of 2335, the grid pattern array may have no more than 100 possibilities in either axis, thus a software program can select the first two digits (e.g. 23) as a first coordinate and the next two digits (e.g., 35) for a second coordinate.

Alternatively, a cell may be color coded for access on a key pad. For example, a cell may have up to 4 colors (e.g., one color assigned to each quadrant of the cell). The color coding starts at a quadrant and moves clockwise, counter clockwise, and or diagonally. For instance, in a clockwise example, a first color is in the upper left hand quadrant, followed by a second color in the upper right had quadrant, then followed by a third color in the lower right hand quadrant, and finally a fourth color in the lower left hand quadrant. Other variations are possible, or more than 4 different colors may be encoded into a cell. A keypad may include keys with the colors used in the cells, or alphabet and or numeral code in the keys associated with the color coded scheme of the cells. For example, if four colors, red, green, blue, and or yellow are used in the cells, a keypad may include R, G, B, and or Y keys for enabling or accessing a cell in the programming guide.

Another embodiment may include an application on an apparatus that substantially mirrors a displayed programming guide from a television set or media player or set top box, media extender, etc. Typically this application may be included in a remote control, a cell phone or other computing and or receiving device that has a link to the television, media player, and or set top device. With a touch screen on a remote control or cell phone, the cells of a programming guide (grid array) may be enabled quickly (e.g., without conventionally scrolling through the cells) for access in selection of channels and or programs on the television set, media player, or set top box.

It should be noted that any of the embodiments may be combined with any combination of signals, methods, or apparatuses such as content control signals, or modification of video signals as described in U.S. Pat. Nos. 4,631,603; 4,819,098; 5,130,810; 5,315,448; 5,583,936; 6,381,747; 6,501,842; 6,516,132; 6,600,873; 6,836,549; 7,039,294; 7,050,698; 7,085,380; 7,492,896; 7,395,545, which are all incorporated by reference.

It is to be understood that any embodiment or feature as described above may be combined with another embodiment or feature to provide a combination of features.

This disclosure is illustrative and not limiting. Further modifications will be apparent to those skilled in the art in light of this disclosure and are intended to fall within the scope of the appended claims.

1-14. (canceled)

15. A method of providing navigation around an electronic programming guide, the method comprising:
generating for display a collection of cells organized in rows and columns, or cells in a grid pattern;
generating for display date or time information in a direction of a first axis of the programming guide and channel identification in a direction of a second axis of the programming guide, wherein each cell includes programming information which is associated with a channel and time, and wherein a collection of cells is arranged in columns and rows; and
receiving a user selection to shift one or more cells, but less than all cells, forward or backward or up or down while leaving at least one cell unshifted.

16-29. (canceled)

30. The method of claim 15, wherein one or more cells of the collection of cells comprises text or picture information associated with a particular channel and time.

31. The method of claim 15, wherein one or more cells of the collection of cells comprises a hyperlink to a digital delivery network, wherein a user selection of the hyperlink retrieves a program associated with the hyperlink to be displayed.

32. The method of claim 31, wherein the program associated with the hyperlink is a program that aired previously.

33. The method of claim 15, further comprising:
generating for display an indication of hidden information in a cell by modulating the visual appearance of the cell based o a time-dependent signal.

34. The method of claim 33, wherein modulating the visual appearance of the cell comprises modulating a color channel associated with a cell pixel based on the time-dependent signal.

35. The method of claim 33, wherein the time-dependent signal is generated for display in response to a user selection of the cell.

36. The method of claim 15, wherein content associated with a cell of the collection of cells is generated for display within the cell in response to receiving a user selection to enable the cell.

37. The method of claim 15, wherein the content associated with the cell is a headline that moves across the cell.

38. The method of claim 15, wherein shifting the one or more cells comprises shifting channels to provide to provide navigating along the first axis for one or more channels while leaving at least one other channel unshifted along the first axis.

39. A system for providing navigation around an electronic programming guide, the system comprising:
control circuitry configured to:
generate for display a collection of cells organized in rows and columns, or cells in a grid pattern;
generate for display date or time information in a direction of a first axis of the programming guide and channel identification in a direction of a second axis of the programming guide, wherein each cell includes programming information which is associated with a channel and time, and wherein a collection of cells is arranged in columns and rows; and
receive a user selection to shift one or more cells, but less than all cells, forward or backward or up or down while leaving at least one cell unshifted.

40. The system of claim 39, wherein one or more cells of the collection of cells comprises text or picture information associated with a particular channel and time.

41. The system of claim 39, wherein one or more cells of the collection of cells comprises a hyperlink to a digital delivery network, wherein a user selection of the hyperlink retrieves a program associated with the hyperlink to be displayed.

42. The system of claim 41, wherein the program associated with the hyperlink is a program that aired previously.

43. The system of claim 39, wherein the control circuitry is further configured to generate for display an indication of hidden information in a cell by modulating the visual appearance of the cell based on a time-dependent signal.

44. The system of claim 43, wherein modulating the visual appearance of the cell comprises modulating a color channel associated with a cell pixel based on the time-dependent signal.

45. The system of claim 43, wherein the time-dependent signal is generated for display in response to a user selection of the cell.

46. The system of claim 39, wherein content associated with a cell of the collection of cells is generated for display within the cell in response to receiving a user selection to enable the cell.

47. The system of claim 39, wherein the content associated with the cell is a headline that moves across the cell.

48. The system of claim 39, wherein shifting the one or more cells comprises shifting channels to provide to provide navigating along the first axis for one or more channels while leaving at least one other channel unshifted along the first axis.
